(19) United States
(12) Patent Application Publication
(10) Pub. No.: US 2026/0238112 A1
(43) Pub. Date: Aug. 13, 2026

(54) HOLD-UP TIME CIRCUIT FOR LLC CONVERTER

(71) Applicant: AES Global Holdings PTE Ltd., Singapore (SG)

(72) Inventors: GuangWei Xu, Shenzhen (CN); LongFei Zou, Shenzhen (CN); Mengdie Hu, Shenzhen (CN)

(21) Appl. No.: 18/703,416

(22) PCT Filed: Oct. 21, 2021
(86) PCT No.: PCT/CN2021/125358

§ 371 Date: Apr. 21, 2025

(51) Int. Cl. H02M 1/00; H02M 3/00; H02M 3/335

(52) U.S. Cl. CPC H02M 1/0096; H02M 3/01; H02M 3/33571; H02M 3/33592

(57) ABSTRACT

A power converter comprises switching elements coupled in series across a voltage input, a resonant circuit, an output circuit, and a controller. The output circuit comprises one or more windings coupleable to a winding of the resonant circuit, a plurality of switching devices coupled to the one or more windings, and a switch assembly coupled to the one or more windings. The plurality of switching devices is configured to supply an output voltage in response to a current flowing through at least one switching device of the plurality of switching devices and through at least one of the one or more windings. The controller is configured to control the switch assembly into a conducting state to cause a current flowing through the output circuit to flow through the one or more windings without flowing through the plurality of switching devices.

### CROSS-REFERENCE TO RELATED APPLICATIONS

This application is a 371 of and claims the benefit and priority of PCT Application No.: PCT/CN2021/125358, filed Oct. 21, 2021. The entire disclosure and contents of the above application are incorporated herein by reference.

### BACKGROUND

Embodiments of the present disclosure relate to power supplies and, more particularly, to increasing a hold-up time in resonant LLC power converters.

Resonant LLC converter topology is widely used due to its zero-voltage-switching (ZVS) capability, low-voltage stress, high efficiency performance, and its ability to achieve high power density. However, there is a trade-off between the high efficiency and long hold-up time performance in a resonant converter.

Generally, the hold-up time of a converter is the amount of time (typically in milliseconds) that a power converter can continue to generate output within a specified range after an input power interruption. Efficiency can be increased significantly with, for example, an increase ratio of transformer magnetizing inductance/resonant choke inductance. However, the hold-up time will consequently decrease as well. Alternatively, efficiency may be sacrificed for long hold-up time performance. For example, to get a longer hold up time, a lower ratio (Lm/Lr) may be designed. However, this action will lower efficiency. One solution for maintaining high efficiency performance while achieving long hold-up time.

### BRIEF STATEMENT

In accordance with one aspect of the present disclosure, a power converter comprises a first voltage input, a first switching element and a second switching element coupled in series across the first voltage input, a resonant circuit coupled to the first and second switching elements, an output circuit, and a controller. The first voltage input comprises a first input terminal and a second input terminal. Each of the first and second switching elements having a conducting state and a non-conducting state. The resonant circuit comprises a first inductor, a first winding of a transformer, and one or more resonant capacitors. The output circuit comprises a voltage output, one or more second windings coupled to the voltage output and inductively coupleable to the first winding, a plurality of switching devices coupled to the voltage output and to the one or more second windings, and a switch assembly coupled to the one or more second windings. The plurality of switching devices is configured to supply an output voltage to the voltage output in response to a current flowing through at least one switching device of the plurality of switching devices and through at least one of the one or more second windings. The switch assembly has a conducting state and a non-conducting state. The controller is coupled to the switch assembly and configured to control the switch assembly into the conducting state to cause a current flowing through the output circuit to flow through the one or more second windings without flowing through the plurality of switching devices.

In accordance with another aspect, a method is provided for controlling a boost switch assembly of a power converter during a hold-up time, the power converter comprising a voltage input, a pair of switching elements, a resonant circuit, and an output circuit having a voltage output, wherein the resonant circuit has an inductor, a first transformer winding, and a capacitor, wherein the output circuit has a plurality of second transformer windings coupled to the voltage output and a plurality of switching devices coupled to the voltage output. The method comprises controlling the boost switch assembly into a conducting state during a first portion of the hold-up time to cause a current flowing through the plurality of second transformer windings to circulate through the plurality of second transformer windings without flowing through the voltage output.

### BRIEF DESCRIPTION OF THE DRAWINGS

The drawings illustrate embodiments presently contemplated for carrying out the invention.

In the drawings:

FIG. 1 is a circuit block diagram illustrating a power converter according to an example.

FIG. 2 illustrates a resonant half-bridge LLC converter according to an example.

FIG. 3 illustrates control signal waveforms usable during a hold-up time sequence according to an example.

FIG. 4 illustrates a current flow through the LLC converter of FIG. 2 during a first time period of the control signal waveforms of FIG. 3 according to an example.

FIG. 5 illustrates a current flow through the LLC converter of FIG. 2 during a second time period of the control signal waveforms of FIG. 3 according to an example.

FIG. 6 illustrates a current flow through the LLC converter of FIG. 2 during a third time period of the control signal waveforms of FIG. 3 according to an example.

FIG. 7 illustrates a current flow through the LLC converter of FIG. 2 during a fourth time period of the control signal waveforms of FIG. 3 according to an example.

FIG. 8 illustrates a current flow through the LLC converter of FIG. 2 during a fifth time period of the control signal waveforms of FIG. 3 according to an example.

FIG. 9 illustrates a current flow through the LLC converter of FIG. 2 during a sixth time period of the control signal waveforms of FIG. 3 according to an example.

FIG. 10 illustrates control signal waveforms usable during a hold-up time sequence according to another example.

FIG. 11 illustrates control signal waveforms usable during a hold-up time sequence according to another example.

FIG. 12 illustrates a flowchart of a hold-up time procedure according to an example.

FIG. 13 illustrates an example of the LLC converter of FIG. 2 together with an implementation of the boost switch assembly according to an example.

FIGS. 14-17 illustrate alternative boost switch circuit arrangements according to examples.

### DETAILED DESCRIPTION

Examples of the present disclosure will now be described more fully with reference to the accompanying drawings. The following description is merely exemplary in nature and is not intended to limit the present disclosure, application, or uses.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

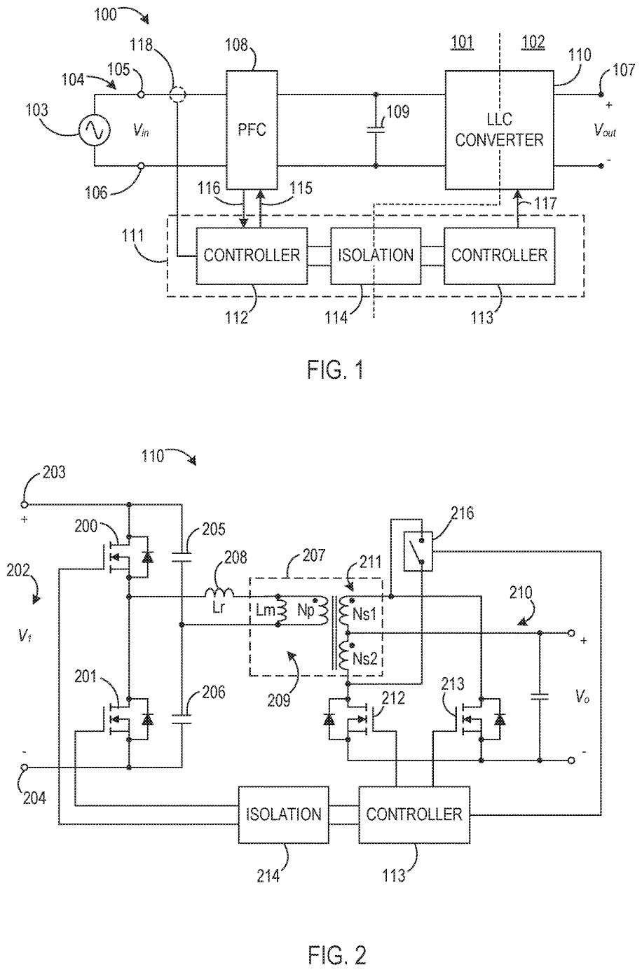

FIG. 1 illustrates a circuit block diagram of a power converter 100 having a primary side 101 and a secondary side 102. The power converter 100 receives a voltage such as an AC voltage from a voltage source 103 via a voltage input 104 having input terminals input terminal 105, 106 and converts the received voltage to a DC voltage for supply to a load via a voltage output 107. An AC-DC converter such as a power factor correction PFC converter 108 converts the input AC voltage to a DC voltage that is output to a bulk capacitor 109 and to a DC-DC converter implemented according to aspects disclosed herein as an LLC converter 110. In an example, the PFC converter 108 includes a bridged or a bridgeless PFC circuit (not shown) that boosts the input AC voltage to a higher voltage and supplies the boosted DC voltage to the bulk capacitor 109 and to the LLC converter 110.

The power converter 100 also includes a control circuit 111 for controlling one or more power switches (not shown) in the power converters 108, 110. As shown in FIG. 1, the control circuit 111 includes a primary side controller 112, a secondary side controller 113, and an isolation component 114 coupled between the primary side controller 112 and the secondary side controller 113. The isolation component 114 may include, for example, an optocoupler, a transformer, etc.

The primary side controller 112 controls one or more power switches in the AC-DC power converter 108. For example, the primary side controller 112 may generate one or more control signals 115 for controlling the power switches of the AC-DC power converter 108 for correcting a power factor. The control signals 115 may be generated based on a sensed parameter 116 (e.g., an AC input current, an AC input voltage and/or a DC bulk voltage) of the AC-DC power converter 108, the power converter 100, etc. As shown in FIG. 1, the secondary side controller 113 controls switches (FIG. 2) in the resonant LLC power converter 110. For example, the secondary side controller 113 may generate one or more control signals 117 for controlling one or more power switches (e.g., metal-oxide-semiconductor field-effect transistors (MOSFETs)) and/or one or more synchronous rectifiers (e.g., MOSFETs).

FIG. 2 illustrates a circuit diagram for the LLC converter 110 of FIG. 1 according to an example. As shown, the LLC converter 110 is a resonant half-bridge LLC series converter. However, other resonant converters are contemplated such as a full-bridge LLC series converter, half-or full-bridge LCC converters, and the like. The LLC converter 110 includes two primary power switches 200-201 coupled to a voltage input 202 having a pair of input terminals 203-204, two resonant capacitors 205-206, a transformer 207, a resonant inductor 208 coupled to a primary side 209 of the transformer 207, and rectifying circuit 210 coupled to a secondary side 211 of the transformer 207. The capacitors 205-206 and the inductor 208 form the resonant LLC tank. The rectifying circuit 210 is shown as a half-wave rectifier including a pair of synchronous rectifier switches 212-213 coupled to a center-tapped secondary winding (e.g., Ns1, Ns2) of the transformer 207. In other configurations, the rectifying circuit 210 may include diodes in place of the synchronous rectifier switches 212-213.

As shown in FIG. 2, secondary side controller 113 may be configured to drive the power switches 200-201 through an isolation component 214. In one example, the isolation component 214 may be the isolation component 114 illustrated in FIG. 1 or be a part thereof. In other examples, the isolation component 214 may be an additional isolation component for controlling the power switches 200-201.

A controllable boost switch assembly 216 is coupled in parallel with the transformer secondary side windings Ns1, Ns2. The secondary side controller 113 is coupled to the boost switch assembly 216 and controls the boost switch assembly 216 into a closed or conducting state that connects the secondary windings together in an antiparallel arrangement or into an open or non-conducting state that disconnects the antiparallel coupling.

Referring to FIGS. 1 and 2, during a normal operating condition (e.g., wherein the input power from the voltage source 103 to the voltage input 104 is on or is greater than or equal to a predetermined threshold as may be determined, for example, by comparison of the input voltage or current sensed via a voltage or current sensor 118 to the predetermined threshold), the controller 113 controls the boost switch assembly 216 into its off state either by disabling control signals to the boost switch assembly 216 (e.g., such as to a gate of a switching element of the boost switch assembly 216) or by reducing the magnitude of the control signals to below that of an internal threshold for the boost switch assembly 216. During the normal operating condition, the power switches 200-201 are alternately turned on and off to achieve the high efficiency, low EMI, and high-power density benefits of the resonant LLC converter topology.

However, in response to a failure in the voltage source 103 to deliver sufficient voltage to the power converter 100 or in response to any equivalent condition that would prompt the voltage across the bulk capacitor 109 to drop below a predetermined bulk capacitor threshold, the controller 113 is programmed to identify the presence of a hold-up time condition and to subsequently generate control signals to extend power delivery to the voltage output 107.

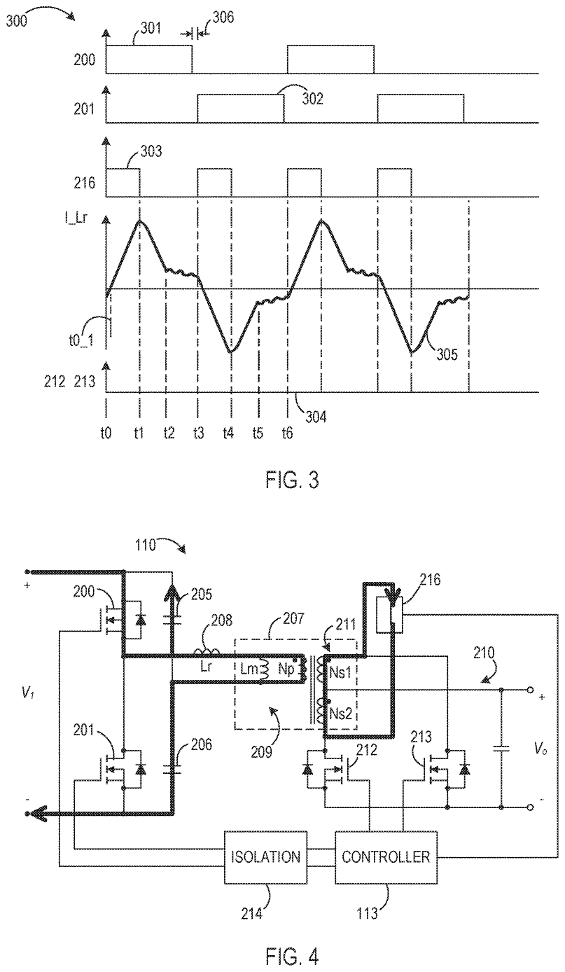

In response to detecting a hold-up time condition, FIG. 3 illustrates a control scheme 300 employable by the secondary side controller 113 to extend delivery of the desired voltage output according to an example. The input voltage to the LLC converter 110 during the hold-up time condition may be supplied by the energy stored in the bulk capacitor 109 prior to the loss of AC input voltage. The stored energy allows the LLC converter 110 to continue providing an output voltage for a period of time.

The control scheme 300 includes control signal waveforms for controlling the on and off states of the power switches 200, 201 and the boost switch assembly 216. First and second signal waveforms 301-302 are illustrated for controlling the on/off states of the primary side power switches 200-201, respectively. A further boost switch assembly signal waveform 303 illustrates control of the boost switch assembly 216 into its on and off states. In the control scheme 300 illustrated in FIG. 3, the synchronous rectifier switches 212-213 are maintained in their off or non-conducting states by a synchronous rectifier signal waveform 304 that stays low throughout the scheme 300. Notwithstanding the low signal waveform 304, current may flow through the synchronous rectifier switches 212-213 during the hold-up time sequence as a consequence of flowing through the respective body diodes of the synchronous rectifier switches 212-213.

Referring to the time periods t0-t6, operation of the primary power switches 200-201 and boost switch assembly 216 will be explained. In the time interval t0-t1, the primary power switch 200 is active or controlled into its on state, and primary power switch 201 is inactive or controlled into its off state. The boost switch assembly 216 is also controlled into its on state, which shorts the transformer windings Ns1, Ns2. As a result of turning on the boost switch assembly 216, the transformer exciting magnetic voltage is zero, and current induced in the secondary windings Ns1, Ns2 circulates through the secondary windings. No secondary side current flows to the output Vo through secondary rectifier switch components 212, 213. As illustrated in the current curve (I_Lr) 305 through the resonant inductor (Lr) 208, after a brief introductory interval (e.g., t0-t0_1), the voltage V1 supplied by the bulk capacitor 109 to the voltage input of the LLC converter 110 causes current to flow through the primary power switch 200 and into the resonant tank. FIG. 4 illustrates current flow (e.g., thick arrows) through the LLC converter 110 during the time period t0_1-t1 in an example. The voltage of the resonant choke 208 is equal to V1 minus the voltage across the capacitor 206. The shorting of the secondary windings of the transformer 207 by the boost switch assembly 216 adds a higher voltage on the resonant choke 208, saving more energy to boost the voltage gain.

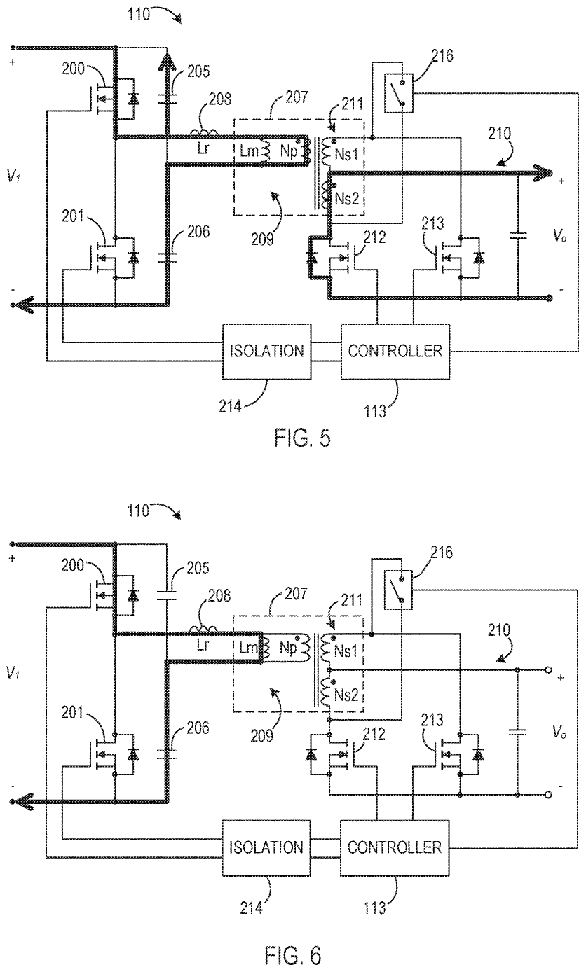

Referring back to FIG. 3, the boost switch assembly 216 is turned off for the time period t1-t2 while the primary power switch 200 remains on and the primary power switch 201 remains off. The current induced in the resonant choke flows through the transformer primary winding Np and through the secondary winding Ns2 and the secondary synchronous rectifier switch 212 via its body diode to supply an output voltage to the output Vo. The current curve 305 of FIG. 3 and the current flow (e.g., thick arrows) through the LLC converter 110 illustrated in FIG. 5 show the effects of the current for the time period t1-t2.

At time period t2-t3, a freewheeling operation of the resonant choke occurs in response to the resonant current of the second time period (e.g., t1-t2) reaching the magnetizing current of the transformer 207. At t2, the current of the secondary rectifier 212 crosses to zero and shuts off, resulting in the inductor 208 starting a high frequency resonance with the resonant tank inductor and parasitic capacitors of secondary rectifiers 212, 213 through transformer 207. The current curve 305 of FIG. 3 and the current flow (e.g., thick arrow) through the LLC converter 110 illustrated in FIG. 6 show the effects of the current for the time period t2-t3. As illustrated in FIG. 3, brief dead times 306 may exist between turn-on commands in the first and second signal waveform 301, 302 to avoid short-circuits between the primary power switches 200, 201.

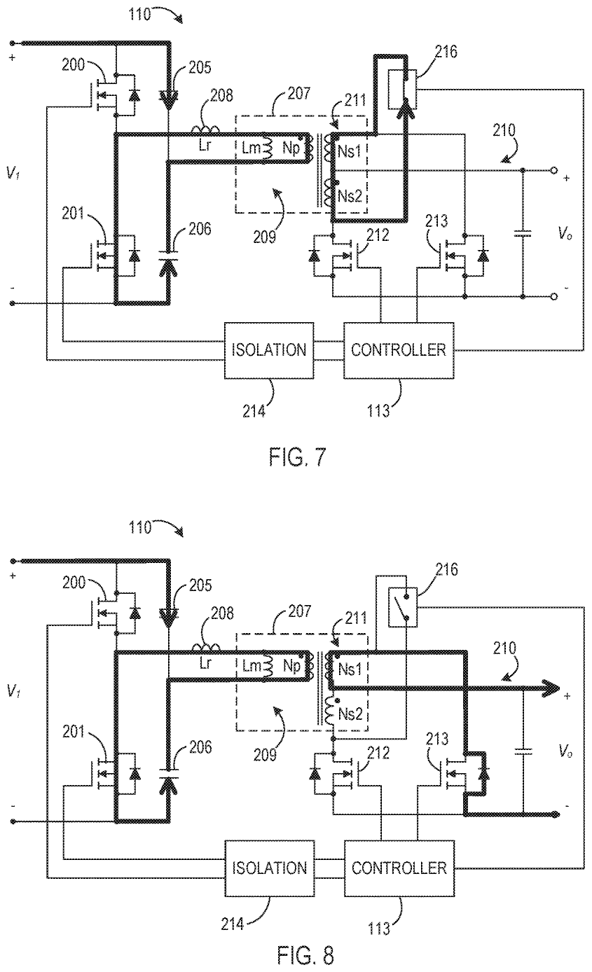

At time period t3-t4, the primary power switch 200 is off, and the primary power switch 201 and boost switch assembly 216 are on. As a result, current flows through the primary winding Np of the transformer 207, the inductor 208, the power switch 201, and resonant capacitors 205, 206. The transformer exciting magnetic voltage is zero, and current induced in the secondary windings Ns1, Ns2 circulates through the secondary windings. With the transformer 207 shorted by the boost switch assembly 216, the transformer exciting magnetic voltage is 0, current doesn't flow to output through secondary rectifier switches. The voltage of the resonant choke 208 is equal to 0 minus the voltage across the capacitor 206. FIG. 7 shows the negative current flow (e.g., thick arrows) through the LLC converter 110 for the time period t3_1-t4.

At time period t4-t5, the primary power switch 201 remains on, the primary power switch 200 remains off, and the boost switch assembly 216 is turned off. The current induced in the resonant choke 208 flows through the transformer primary winding Np and through the secondary winding Ns1 and the synchronous rectifier switch 213 via its body diode to supply an output voltage to the output Vo. The current curve 305 of FIG. 3 and the current flow (e.g., thick arrows) through the LLC converter 110 illustrated in FIG. 8 show the effects of the current for the time period t4-t5.

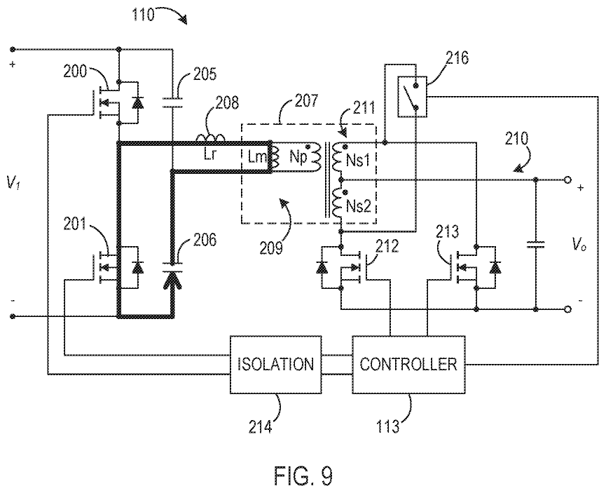

At time period t5-t6, the freewheeling operation of the resonant choke begins again in response to the resonant current of the fifth time period (e.g., t4-t5) reaching the magnetizing current of the transformer 207. At t5, the current of secondary rectifier 213 crosses to zero and shuts off, resulting in the inductor 208 starting a high frequency resonance with the resonant tank inductor and parasitic capacitors of secondary rectifier 212, 213 through transtormer 207. The current curve 305 of FIG. 3 and the current flow (e.g., thick arrow) through the LLC converter 110 illustrated in FIG. 9 show the effects of the current for the time period t5-t6.

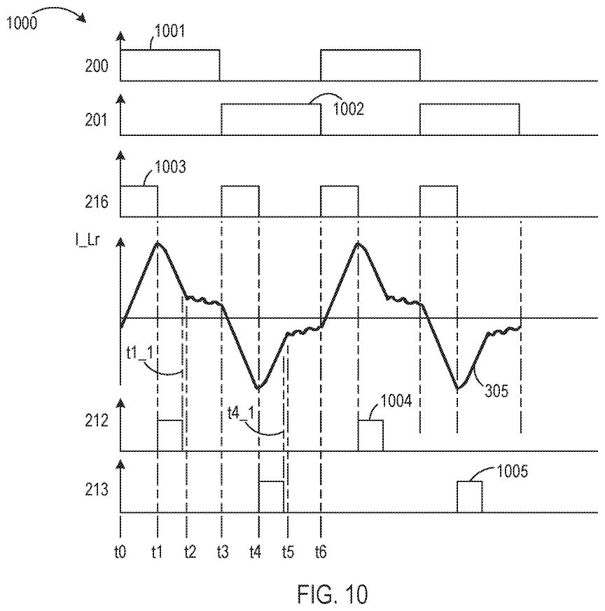

FIG. 10 illustrates a control scheme 1000 employable by the secondary side controller 113 to extend delivery of the desired voltage output according to another example. In the control scheme 1000, signal waveforms 1001, 1002, 1003 correspond with waveforms 301-303 of the control scheme 300 and operate as described above to control the on and off states of the respective power switches 200, 201 and boost switch assembly 216.

In contrast to the control scheme 300 illustrated in FIG. 3 where the current flow during the time periods t1-t2 and t4-t5 passes mainly through the body diodes of the synchronous rectifier switches 212, 213, the control scheme 1000 includes signal waveforms 1004, 1005 that command the synchronous rectifier switches 212, 213 into their on states during at least a portion of the time in time periods t1-t2 and t4-t5 to allow the current to flow through the switches 212, 213 rather than through their body diodes. In this manner, conduction losses may be reduced. As illustrated, the width of the PWM pulse of the signal waveform 1004 in the time period t1-t2 is less than the width of the time period t1-t2. For example, the width of the PWM pulse extends between t1 and t1_1. Likewise, the width of the PWM pulse of the signal waveform 1005 in the time period t4-t5 extends between t4 and t4_1. In some examples, the widths of the time periods t1-t1_1 and t4-t4_1 are substantially equal to the widths of the respective time periods t0-t1 and t3-t4.

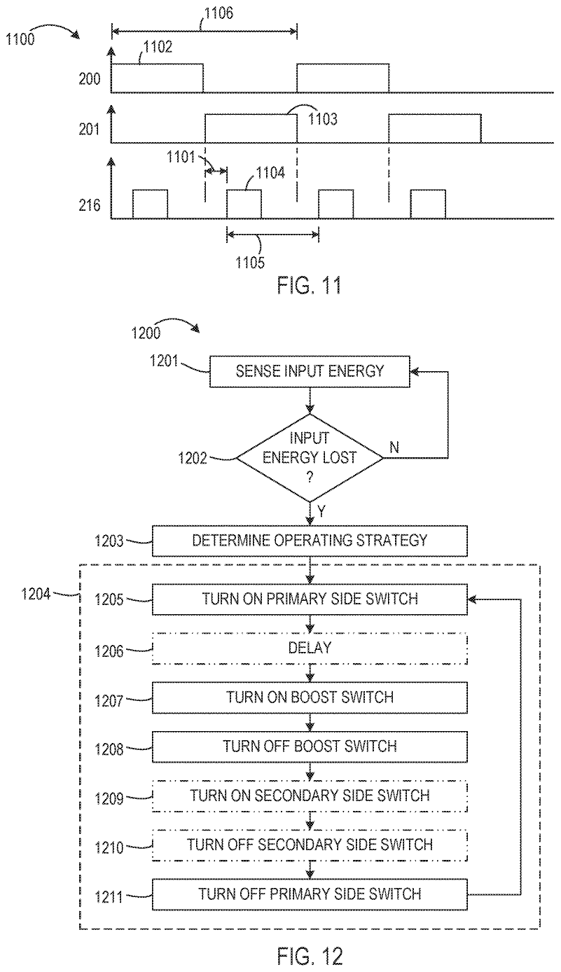

FIG. 11 illustrates a control scheme 1100 having a delay 1101 between the start of a PWM pulse in the signal waveforms 1102, 1103 and a corresponding PWM pulse in the waveform 1104 controlling the boost switch assembly 216. While illustrated as a positive delay, the delay 1101 may be positive, zero, or negative in alternative examples. FIG. 11 further illustrates that the frequency 1105 of the PWM pulses of the waveform 1104 for controlling the boost switch assembly 216 is higher than the frequency 1106 of the PWM pulses of the waveforms 1102, 1103 for controlling the power switches 200, 201. In one example, the frequency 1105 is twice the frequency 1106.

FIG. 12 illustrates a flowchart for a hold-up time procedure 1200 implementing a control scheme according to an example. The control scheme implemented may be based on any of the control schemes 300, 1000, 1100 disclosed herein. The hold-up time procedure 1200 may be executed by secondary side controller 113 or by another controller working together with the secondary side controller 113 in an example.

The procedure 1200 begins by detecting a loss of AC input energy. At step 1201, the AC input voltage or current is sensed using, for example, the sensor 118 (FIG. 1) and compared with an input energy threshold to determine if the energy supply is lost (e.g., the input energy is off) or is not lost. At step 1202, the procedure 1200 determines whether the AC input energy is lost. If the input energy is not lost, process control returns to step 1201, and the LLC converter 110 may continue to operate under normal or regular operation conditions to convert the input energy into an output energy for supply to a load coupled to the voltage output 107. If the input energy is lost, the procedure 1200 begins a hold-up time control sequence.

At step 1203, an operating strategy for the signal waveforms for the power switches 200, 201 and for the turn on duration of the boost switch assembly 216 may be determined. Alternatively, the operating strategy may be pre-determined and stored in memory for retrieval during the procedure 1200. For a first boost gain strategy in one example, the operating frequencies of the power switches 200, 201 may be fixed to a value, and the turn on duration for the boost switch assembly 216 may be adjusted one or more times throughout the hold-up time to achieve a desired boost result. In another example, the turn on duration for the boost switch assembly 216 may be fixed while the operating frequencies of the power switches 200, 201 are adjusted to achieve the desired boost result. In another strategy, both the turn on duration for the boost switch assembly 216 and the operating frequencies of the power switches 200, 201 may be adjusted during the hold-up time to achieve the desired boost result. In general, the operating frequencies of the power switches 200, 201 during the hold-up time become lower than the corresponding operating frequencies during the normal operation in order to maintain a voltage gain sufficient to provide substantially the same output power during the hold-up time as during the normal operating conditions. The frequency of switches 200 and 201 can be higher lower or equal to LLC resonant frequency.

Following determination of the operating strategy, an iterative loop 1204 may be performed. The loop begins at step 1205 by turning on a first primary-side switch such as one of the power switches 200, 201 at time t0 or t3. As described with respect to FIG. 11, an optional delay may be implemented at step 1206 before the boost switch assembly 216 is turned on. At step 1207, the boost switch assembly 216 is turned on. If a delay is employed at step 1206, the boost switch assembly 216 is turned on according to the delay. If no delay is used, the boost switch assembly 216 may be turned on together with the selected primary-side switch at time t0 or t3 or before or after. The boost switch assembly 216 is turned off according to the operating strategy after the turn on time has expired at step 1208 at time t1 or t4 while the primary-side switch remains in its on state.

At steps 1209, 1210, the corresponding secondary-side switch may be turned on and off at respective time steps t1, t4 and t1_1, t4_1 to reduce conduction losses as described above. The primary-side switch is subsequently turned off at step 1211 at the end of the on portion of the operating strategy for the current primary-side switch (e.g., times t3 or t6).

While the hold-up time procedure remains in use, the procedure 1200 may begin the iterative loop 1204 again in order to control the other primary-side switch and its respective synchronous rectifier switch (if used) in steps 1205-1209. The hold-up time procedure 1200 may end in response to a restoration of the input voltage to the voltage input 104 of the power converter 100 or in response to a voltage level of the bulk capacitor 109 decreasing to or past a minimum voltage threshold.

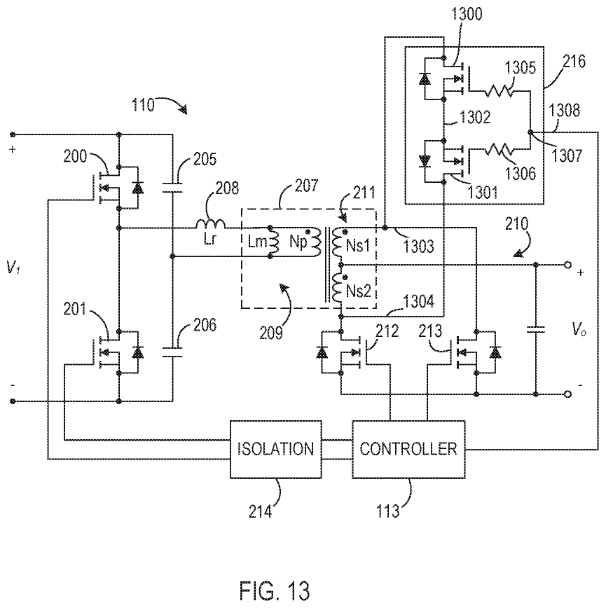

FIG. 13 illustrates a circuit diagram for the LLC converter 110 of FIG. 1 showing an implementation for the boost switch assembly 216 according to an example. As shown, the boost switch assembly 216 includes a pair of MOSFET switching devices 1300, 1301 serially coupled together at a first node 1302. The pair of MOSFETs are coupled in parallel via the first MOSFET 1300 being coupled to a first terminal of the secondary winding Ns1 at a second node 1303 and via the second MOSFET 1301 being coupled to a second terminal of the secondary winding Ns2 at a third node 1304. A pair of resistors 1305, 1306 coupled to the MOSFETs 1300, 1301 and to each other at a fourth node 1307 provide an input connection to the boost switch assembly 216 for coupling with a boost switch output 1308 of the secondary side controller 113 for controlling the MOSFETs 1300, 1301 into their on and off states as described herein with respect to the boost switch assembly 216.

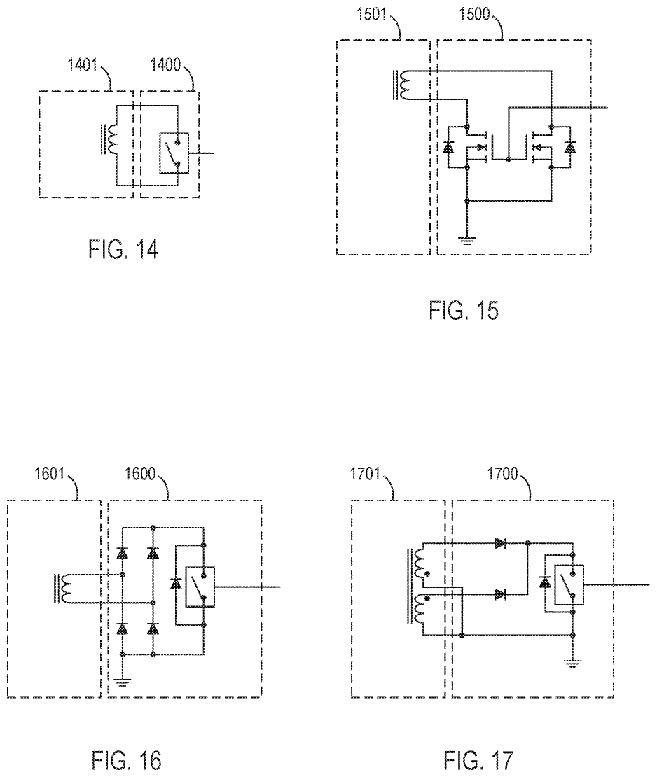

FIGS. 14-17 illustrate simplified circuit diagrams of alternative boost switch assemblies according to examples. FIG. 14 illustrates a boost switch assembly 1400 coupled in parallel with a single inductive winding 1401. The boost switch assembly 1400 may be implemented in a similar manner as the boost switch assembly 216 illustrated in FIG. 13. FIGS. 15 and 16 illustrate common ground drive circuit diagrams 1500, 1600 for a single inductive winding 1501, 1601 according to examples. FIG. 17 illustrates a common ground drive circuit diagram 1700 for two non-serially coupled windings 1701. The windings 1401, 1501, 1601, 1701 illustrated in FIGS. 14-17 may be any type of winding such as power windings, auxiliary windings, primary windings, secondary windings, floating windings, and the like.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the present disclosure. Additionally, while various embodiments of the present disclosure have been described, it is to be understood that aspects of the present disclosure may include only some of the described embodiments. Accordingly, the invention is not to be seen as limited by the foregoing description but is only limited by the scope of the appended claims.

What is claimed is:

1. A power converter comprising:
a first voltage input comprising a first input terminal and a second input terminal;
a first switching element and a second switching element coupled in series across the first voltage input, each of the first and second switching elements having a conducting state and a non-conducting state;
a resonant circuit coupled to the first and second switching elements and comprising:
a first inductor;
a first winding of a transformer; and
one or more resonant capacitors;
an output circuit comprising:
a voltage output;
one or more second windings coupled to the voltage output and inductively coupleable to the first winding;
a plurality of switching devices coupled to the voltage output and to the one or more second windings and configured to supply an output voltage to the voltage output in response to a current flowing through at least one switching device of the plurality of switching devices and through at least one of the one or more second windings; and
a switch assembly coupled to the one or more second windings and having a conducting state and a non-conducting state; and
a controller coupled to the switch assembly and configured to:
control the switch assembly into the conducting state to cause a current flowing through the output circuit to flow through the one or more second windings without flowing through the plurality of switching devices.

2. The power converter of claim 1, wherein the controller is further configured to control the switch assembly into the non-conducting state to cause the current flowing through the output circuit to flow through the one or more second windings and through the plurality of switching devices to generate a voltage at the voltage output.

3. The power converter of claim 2, wherein the controller is further configured to perform a hold-up time procedure, the hold-up time procedure configured to cause the controller to:
control one of the first and second switching elements into the conducting state for a first period of time; and
control the switch assembly into the conducting state for a second period of time;
wherein the first period of time is longer than the second period of time.

4. The power converter of claim 3, wherein the second period of time is less than half of the first period of time.

5. The power converter of claim 3, wherein a beginning of the second time period occurs within the first time period after a delay period.

6. The power converter of claim 3 further comprising:
an AC-DC converter comprising a second voltage input and coupled to the first voltage input;
wherein the controller is further configured to perform the hold-up time procedure in response to a detection of a loss of input energy on the second voltage input.

7. The power converter of claim 6, wherein the controller is further configured to detect the loss of input energy on the second voltage input.

8. The power converter of claim 7, wherein the controller, in being configured to detect the loss of input energy, is configured to:
sense, via a sensor coupled to the second voltage input, a voltage on the second voltage input;
compare the sensed voltage to a threshold value; and
detect the loss of input energy based on the sensed voltage being less than the threshold value.

9. The power converter of claim 6 further comprising a capacitor coupled between the first voltage input and the AC-DC converter.

10. The power converter of claim 1, wherein the switch assembly comprises a pair of MOSFETs serially coupled together; and
wherein the pair of MOSFETs is coupled in parallel with the one or more second windings.

11. The power converter of claim 1, wherein the resonant circuit and the first and second switching elements form a resonant half-bridge LLC series converter.

12. The power converter of claim 1, wherein the output circuit comprises a full-wave rectifier.

13. The power converter of claim 1, wherein the plurality of switching devices comprises:
a first MOSFET coupled to a first terminal of a first winding of the one or more second windings; and
a second MOSFET coupled to a first terminal of a second winding of the one or more second windings;
wherein a second terminal of the first winding is coupled with a second terminal of the second winding.

14. A method for controlling a boost switch assembly of a power converter during a hold-up time, the power converter comprising a voltage input, a pair of switching elements, a resonant circuit, and an output circuit having a voltage output, wherein the resonant circuit has an inductor, a first transformer winding, and a capacitor, wherein the output circuit has a plurality of second transformer windings coupled to the voltage output and a plurality of switching devices coupled to the voltage output, and wherein the method comprises:
controlling the boost switch assembly into a conducting state during a first portion of the hold-up time to cause a current flowing through the plurality of second transformer windings to circulate through the plurality of second transformer windings without flowing through the voltage output.

15. The method of claim 14, wherein the power converter comprises a controller configured to control the boost switch assembly into the conducting state.

16. The method of claim 14 further comprising controlling the boost switch assembly into a non-conducting state during a second portion of the hold-up time to cause a current flowing through at least one winding of the plurality of second transformer windings to circulate through the at least one winding and through the voltage output.

17. The method of claim 16 further comprising controlling a first switching element of the pair of switching elements into a conducting state during a third portion of the hold-up time to cause a current to flow through the first switching element and through the resonant circuit.

18. The method of claim 17, wherein the second portion is after the first portion; and
wherein the third portion overlaps the first and second portions.

19. The method of claim 18 further comprising a first switching device of the plurality of switching devices a conducting state during a fourth portion of the hold-up time to cause a current to flow through the first switching device;
wherein the fourth portion overlaps the second and third portions; and
wherein a time length of the fourth portion is shorter than a time length of the second portion.

20. The method of claim 17 wherein controlling the boost switch assembly into the conducting state during the first portion comprises:
waiting for a delay period after controlling the first switching element into the conducting state; and
controlling the first switching element into the conducting state after the delay period.
